(19) United States
(12) Patent Application Publication
(10) Pub. No.: US 2015/0244631 A1
(43) Pub. Date: Aug. 27, 2015

(54) DEDICATING RESOURCES OF A NETWORK PROCESSOR

(71) Applicants: David A Warren, El Dorado Hills, CA (US); Nandakumar Natarajan, Sunnyvale, CA (US)

(72) Inventors: David A Warren, El Dorado Hills, CA (US); Nandakumar Natarajan, Sunnyvale, CA (US)

(21) Appl. No.: 14/423,708

(22) PCT Filed: Aug. 24, 2012
(86) PCT No.: PCT/US2012/052183

§ 371 Date: Feb. 24, 2015

(51) Int. Cl. H04L 12/851; H04L 29/08; H04L 12/803; H04L 12/725

(52) U.S. Cl. CPC H04L 47/24; H04L 45/302; H04L 67/322; H04L 47/125

(57) ABSTRACT

Disclosed herein are techniques for dedicating resources of a network processor. An interface to dedicate resources of a network processor is displayed. Decisions of the network processor are preempted by the selections made via the interface.

### BACKGROUND

In modern networks, information (e.g., voice, video, or data) is transferred as packets of data. This has lead to the creation of application specific integrated circuits (“ASICs”) known as network processors. Such processors may be customized to receive and route packets of data from a source node to a destination node of a network. Network processors have evolved into ASICs that contain a significant number of processing engines and other resources to manage different aspects of data routing.

### BRIEF DESCRIPTION OF THE DRAWINGS

FIG. 1 is a block diagram of an example system that may be used to dedicate resources of a network processor.

FIG. 2 is a flow diagram of an example method in accordance with aspects of the present disclosure.

FIG. 3 is an example screen shot in accordance with aspects of the present disclosure and a close up illustration of an example network processor.

FIG. 4 is a working example in accordance with aspects of the present disclosure.

### DETAILED DESCRIPTION

As noted above, network processors may contain a significant number of processing engines and other types of resources, such as memory used for queuing packets. As data centers are being moved into virtualized cloud based environments, customers of network computing are provided with a variety of networking options. For example, customers may select from 30 gigabytes to many terabytes of storage. However, allocation of resources in a network processor is controlled by the internal algorithms of the ASIC itself. These internal algorithms, which may be known as quality of service algorithms, determine how to prioritize the ingress and egress of packets. As such, a certain level of performance may not be guaranteed to a customer. For example, a customer paying a premium for high performance may actually receive poor performance when the network processor experiences high packet volume. The load balancing algorithms inside a network processor may not prioritize the packets in accordance with the premiums paid by a customer.

In view of the foregoing, disclosed herein are a system, non-transitory computer readable medium, and method to dedicate resources of a network processor. In one example, an interface to dedicate resources of a network processor may be displayed. In a further example, decisions of the network processor may be preempted by the selections made via the interface. The system, non-transitory computer readable medium, and method disclosed herein permit cloud network providers to offer price structures that reflect the resources of the network processor dedicated to the customer. Furthermore, the techniques disclosed herein permit cloud service providers to maintain a certain level of performance for customers who purchase such a service. The aspects, features and advantages of the present disclosure will be appreciated when considered with reference to the following description of examples and accompanying figures. The following description does not limit the application; rather, the scope of the disclosure is defined by the appended claims and equivalents.

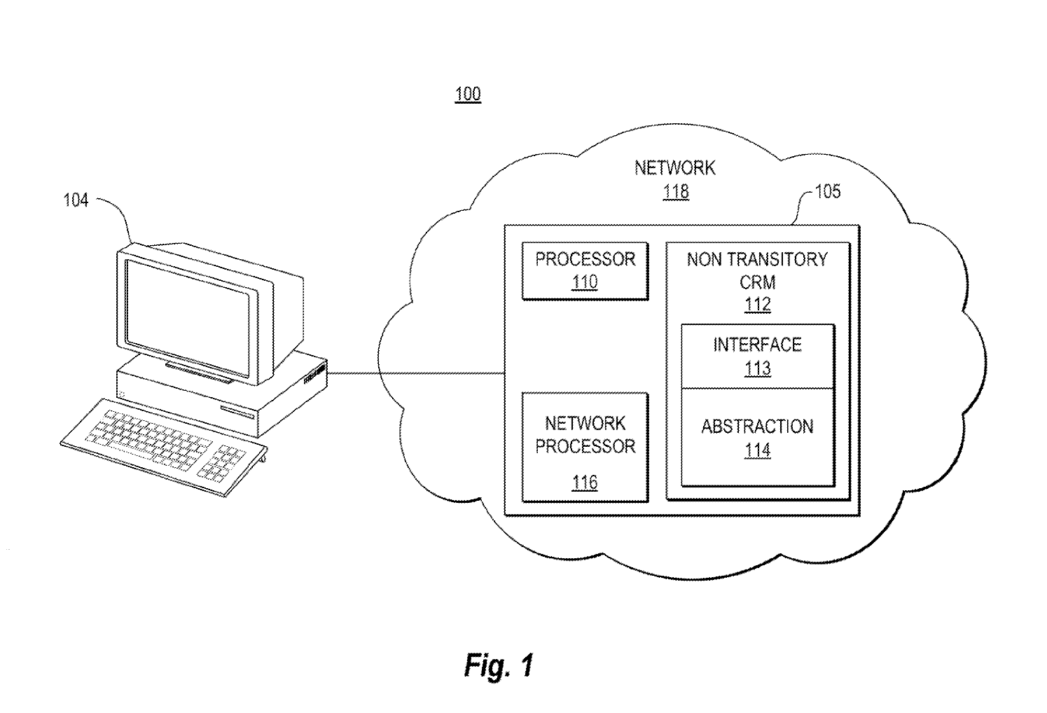

FIG. 1 presents a schematic diagram of an illustrative system 100 in accordance with aspects of the present disclosure. The computer apparatus 105 and 104 may include all the components normally used in connection with a computer. For example, they may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 104 and 105 may also comprise a network interface (not shown) to communicate with other devices over a network, such as network 118.

The computer apparatus 104 may be a client computer used by a customer of a network computing or cloud computing service. The computer apparatus 105 is shown in more detail and may contain a processor 110, which may be any number of well known processors, such as processors from Intel® Corporation. Network processor 116 may be an ASIC for handling the receipt and delivery of data packets from a source node to a destination node in network 118 or other network. While only two processors are shown in FIG. 1, computer apparatus 105 may actually comprise additional processors, network processors, and memories that may or may not be stored within the same physical housing or location.

Non-transitory computer readable medium (“CRM”) 112 may store instructions that may be retrieved and executed by processor 110. The instructions may include an interface layer 113 and an abstraction layer 114. In one example, non-transitory CRM 112 may be used by or in connection with an instruction execution system, such as computer apparatus 105, or other system that can fetch or obtain the logic from non-transitory CRM 112 and execute the instructions contained therein. “Non-transitory computer-readable media” may be any media that can contain, store, or maintain programs and data for use by or in connection with a computer apparatus or instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 105 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well.

Network 118 and any intervening nodes thereof may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Computer apparatus 105 may also comprise a plurality of computers, such as a load balancing network, that exchange information with different nodes of a network for the purpose of receiving, processing, and transmitting data to multiple remote computers. In this instance, computer apparatus 105 may typically still be at different nodes of the network. While only one node of network 118 is shown, it is understood that a network may include many more interconnected computers.

The instructions residing in non-transitory CRM 112 may comprise any set of instructions to be executed directly (such as machine code) or indirectly (such as scripts) by processor 110. In this regard, the terms “instructions,” “scripts,” and “programs” may be used interchangeably herein. The computer executable instructions may be stored in any computer language or format, such as in object code or source code. Furthermore, it is understood that the instructions may be implemented in the form of hardware, software, or a combination of hardware and software and that the examples herein are merely illustrative.

The instructions in interface layer 113 may cause processor 110 to display a graphical user interface (“GUI”). As will be discussed in more detail further below, such a GUI may allow a user to dedicate select resources of a network processor to a customer of a cloud networking service. Abstraction layer 114 may abstract the resources of a network processor from the user of interface layer 113, and may contain instructions therein that cause a network processor to distribute resources in accordance with the selections made at the interface layer.

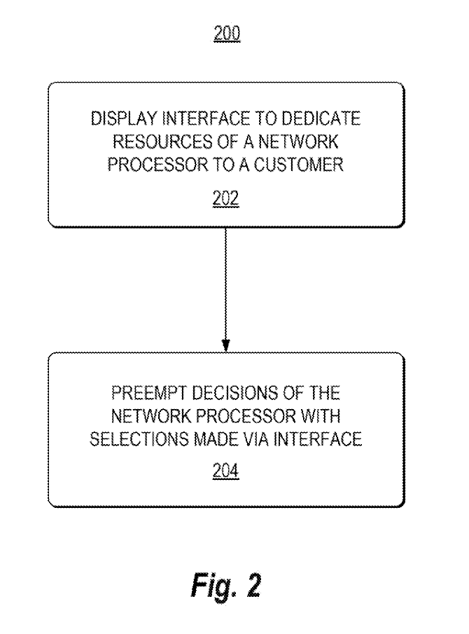

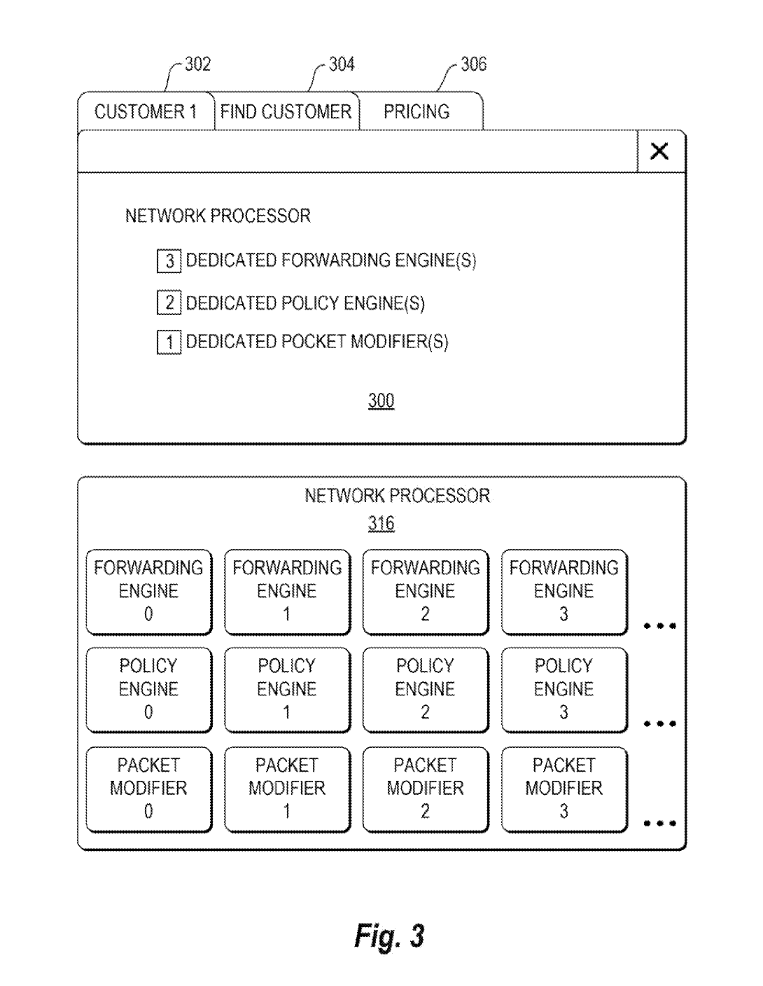

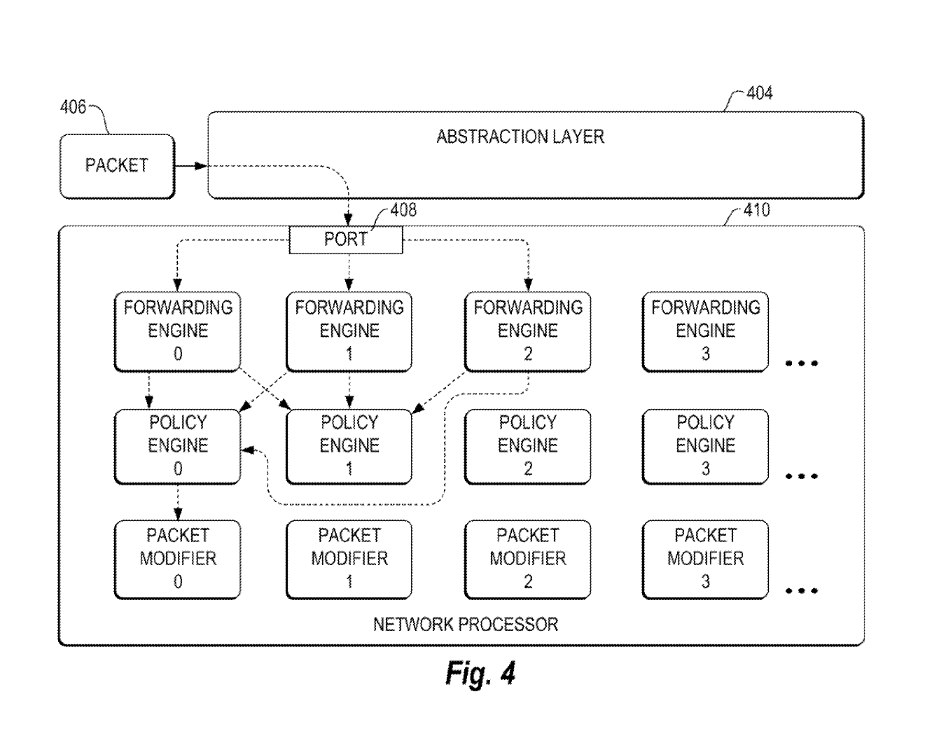

One working example of the system, method, and non-transitory computer-readable medium is shown in FIGS. 2-4. In particular, FIG. 2 illustrates a flow diagram of an example method 200 for dedicating network processor resources in accordance with aspects of the present disclosure. FIGS. 3-4 show a working example in accordance with the techniques disclosed herein. The actions shown in FIGS. 3-4 will be discussed below with regard to the flow diagram of FIG. 2.

As shown in block 202 of FIG. 2, an interface may be displayed that permits a user to dedicate select resources of a network processor to a customer of a network computing service. Referring now to FIG. 3, an illustrative interface 300 is shown having a customer tab 302, a find customer tab 304, and a pricing tab 306. Customer tab 302 may be associated with a user profile of a cloud service customer. In the example of FIG. 3, interface 300 displays network resources dedicated to a customer named “CUSTOMER 1” and it also allows a user to alter those resources. The network resources may include at least one engine in the network processor that manages an aspect of data packet processing or delivery. The find customer tab 304 may permit a user to find another customer's profile and view or alter the resources dedicated thereto. The pricing tab 306 may permit a user to view the different price structures associated with different resource combinations in a network processor. As shown in the example of FIG. 3, “CUSTOMER 1” has 3 dedicated forwarding engines, 2 dedicated policy engines, and 1 dedicated packet modifier engine. These numbers may be altered by changing the numbers indicated in the text box next to each resource name. It should be understood that the engines shown in the screen of FIG. 3 are merely illustrative and that other types of engines or resources of a network processor may be dedicated to a customer via interface 300. For example, interface 300 may allow a user to dedicate an amount of memory to a customer. In a further example, interface 300 may allow a user to dedicate at least one intrusion protection scanner in the network processor. The selections may be made by an administrator of the service, a customer representative, or even the customer. The selections may be recorded in a database, flat file, or any other type of storage.

FIG. 3 also shows a close up illustration of an example network processor 316. As noted above, network processor 316 may include a variety of embedded engines therein to perform some aspect of data packet processing. In this example, network processor 316 may have a plurality of forwarding engines, policy engines, and packet modifier engines. For simplicity, only four engines of each type are depicted in FIG. 3. In one example, a forwarding engine may be defined as a module for handling the receipt and forwarding of data packets from a source node to a destination node. In another example, a policy engine may be defined as a module for determining whether data packets meet certain criteria before delivery. In yet a further example, a packet modifier engine may be defined as a module to add, delete, or modify packet header or packet trailer records in accordance with some protocol. In FIG. 3, forwarding engines, policy engines and packet modifier engines 0 to 3 are shown. As noted above, network processor 316 may also contain various memory modules that may be dedicated to a customer.

Referring back to FIG. 2, packet handling decisions of the network processor may be preempted by the selections made via the interface, as shown in block 204. Resource distribution decisions may be preempted such that the resources in the network processor are distributed in accordance with the selections of the user. Therefore, the packet prioritization decisions of the network processor may be preempted by the preconfigured selections made via the interface. Referring now to FIG. 4, a working example of a packet being routed in a network processor is shown. The packet 406 may be a packet associated with “CUSTOMER 1.” As shown in FIG. 3, “CUSTOMER 1” has 3 dedicated forwarding engines, 2 dedicated policy engines, and 1 dedicated packet modifier engine. The abstraction layer 404 may handle packet 406 before network processor 410 receives the packet. Each customer of the cloud service may be associated with the network resources dedicated thereto using a unique identifier. In one example, the unique identifier may be an internet protocol (“IP”) address, a media access control (“MAC”) address, or a virtual local area network (“VLAN”) tag, which may be indicated in packet 406. In the example of FIG. 4, packets associated with “CUSTOMER 1” may enter network processor 410 using port 408. Abstraction layer 404 may use an application programming interface (“API”) having a set of well defined programming functions to distribute the resources in accordance with the selections of a user. The API may preempt any resource distribution algorithms in the network processor 410. In the example of FIG. 4, forwarding engines 0 thru 2, policy engines 0 thru 1, and packet modifier 0 may be dedicated to “CUSTOMER 1” in accordance with the example screen shot shown in FIG. 3. As such, packet 406 may utilize any combination of these engines. In another example, abstraction layer 404 may be a device driver that communicates the settings made via the interface through a communications subsystem of the host computer.

Abstraction layer 404 may encapsulate the messaging between an interface and a network processor to implement the techniques disclosed herein. Abstraction layer 404 may allocate a data structure or object to each network processor resource dedicated to a customer. In one example, there may be an API function called ResourceMapper( )that associates a customer with the resources of the network processor dedicated thereto. The parameters of the ResourceMapper( )may include a customer identifier, a resource type, and the number of resources to associate with the customer. The function may determine whether the requested resources are available. If so, the resources may be dedicated to the customer. If the resources are not available, the API function may return an error code. In another example, the API may include a function called Balancer( )that balances the load among the dedicated resources. The parameters of the example Balancer( )API function may be the data structures or objects associated with each dedicated resource and a customer identifier. In yet a further example, the Balancer( )function may return a value indicating whether the packets were properly delivered to their destination. In another aspect, the Balancer( )function may return a route within network processor 410 that is least congested. Therefore, the packets associated with the customer may travel along this route. While only two example API functions are described herein, it should be understood that the aforementioned functions are not exhaustive; other functions related to managing network resources in accordance with the techniques presented herein may be added to the suite of API functions.

Advantageously, the foregoing system, method, and non-transitory computer readable medium allow cloud service providers to sustain a certain level of performance in accordance with the expectations of a customer. Instead of exposing a customer to the decisions of a network processor, users may take control of network resources to ensure a certain level of performance.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a network processor to receive data packets and schedule delivery thereof;
an interface layer that permits a user to dedicate select resources of the network processor to a customer of a network computing service; and
an abstraction layer to abstract the resources of the network processor from the user and to preempt resource distribution decisions made in the network processor with selections made by the user via the interface layer.

2. The system of claim 1, wherein the abstraction layer is further a layer to associate the customer with the resources of the network processor dedicated to the customer.

3. The system of claim 1, wherein the resources capable of being dedicated to the customer via the interface layer include at least one engine to manage an aspect of data packet processing.

4. The system of claim 3, wherein the abstraction layer is further a layer to cause the network processor to handle the data packets with the at least one engine selected by the user at the interface layer.

5. The system of claim 1, wherein the abstract layer is further a layer to cause the network processor to prioritize the data packets in accordance with the selections made by the user at the interface layer.

6. A non-transitory computer readable medium with instructions stored therein which, if executed, causes at least one processor to:
display an interface that permits a user to dedicate select resources of a network processor to a customer of a network computing service; and
in response to receipt of a packet associated with the customer, process the packet, using the network processor, in accordance with selections made via the interface such that the selections preempt packet handling decisions by the network processor.

7. The non-transitory computer readable medium of claim 6, wherein the instructions stored therein, if executed, further cause the network processor to prioritize the packet associated with the customer in accordance with the selections made by the user.

8. The non-transitory computer readable medium of claim 6, wherein the instructions stored therein, if executed, further cause the processor to associate the customer of the network computing service with the resources dedicated to the customer.

9. The non-transitory computer readable medium of claim 6, wherein the resources capable of being dedicated to the customer via the interface include at least one engine to manage an aspect of the packet process.

10. The non-transitory computer readable medium of claim 9, wherein the instructions stored therein, if executed, cause the network processor to handle the packet using the at least one engine selected by the user via the interface.

11. A method comprising:
displaying, using a processor, an interface that allows certain resources of a network processor to be dedicated to a customer of a network computing service;
displaying, using the processor, various price structures that reflect the resources of the network processor dedicated to the customer;
determining, using the processor, which resources of the network processor are dedicated to the customer;
accessing, using the network processor, a packet associated with the customer; and
prioritizing, using the network processor, delivery of the packet in accordance with settings preconfigured via the interface such that the settings preempt packet prioritization decisions by the network processor.

12. The method of claim 11, wherein the resources capable of being dedicated to the customer via the interface include at least one engine to manage an aspect of the packet delivery.

13. The method of claim 12, further comprising delivering the packet using the at least one engine of the network processor selected via the interface.

14. The method of claim 11, further comprising associating, using the processor, the customer with the resources dedicated to the customer.
